(19) United States
(12) Patent Application Publication
(10) Pub. No.: US 2009/0075511 A1
(43) Pub. Date: Mar. 19, 2009

(54) SOCKET AND ELECTRICAL ASSEMBLY INCLUDING THE SOCKET

(75) Inventors: David GIVENS, Red Lion, PA (US); Doug MCCARTIN, Henryville, IN (US); John REID, Shepherdsville, KY (US); Jeremy WOOLDRIDGE, Shepherdsville, KY (US)

Correspondence Address: SAMTEC INCORPORATED;C/O KEATING & BENNETT, LLP, 1800 Alexander Bell Drive, SUITE 200, Reston, VA, 20191, US

(73) Assignee: Samtec Inc., New Albany, IN (US)

(21) Appl. No.: 12/133,560

(22) Filed: Jun. 5, 2008

Related U.S. Application Data
(60) Provisional application No. 60/973,073, filed on Sep. 17, 2007.

(51) Int. Cl. H01R 13/62

(52) U.S. Cl. 439/345

(57) ABSTRACT

A socket that electrically connects a memory drive unit to a circuit board includes a socket housing including a base portion having a slot disposed in a central portion therein, sidewalls extending upward from the base portion, and end walls extending upward from the base portion and between the sidewalls, and a locking member arranged to engage a locking structure of a memory drive unit when a memory drive unit is inserted into the memory drive socket. The slot includes a plurality of contacts disposed therein which are arranged to engage corresponding contact pads of the memory drive unit. A bottom surface of the base portion includes at least one pin arranged to engage a through hole of a circuit board. The locking member includes at least one pin disposed at a lower end portion thereof and arranged to be secured to the circuit board.

### BACKGROUND OF THE INVENTION

1. Field of the Invention

The present invention relates to sockets, and more specifically, the present invention relates to memory drive sockets.

2. Description of the Related Art

Internal memory storage devices have long been provided in personal and notebook computers. A common memory storage device is a hard disk drive.

However, hard disk drives are susceptible to being damaged when excessive shock, vibration, and other external forces are applied thereto. In addition, although conventional hard disk drives have relatively high capacities, the access speed thereof is relatively slow.

Other forms of internal memory have also been used, such as RAM and DRAM. However, these forms of internal memory cannot be easily removed and replaced as needed. In addition, these other forms of internal memory also have relatively low capacity although then have relatively high access speeds.

### SUMMARY OF THE INVENTION

In order to overcome the problems described above, preferred embodiments of the present invention provide a memory drive socket that eliminates all of the above-described problems.

A socket for electrically connecting a memory drive unit to a circuit board according to a preferred embodiment of the present invention includes a socket housing including a base portion having a slot disposed in an approximately central portion therein, sidewalls extending upward from the base portion, and end walls extending upward from the base portion and between the sidewalls, and a locking member arranged to engage a locking structure of a memory drive unit when a memory drive unit is inserted into the memory drive socket, wherein the slot includes a plurality of contacts disposed therein which are arranged to engage corresponding contact pads of the memory drive unit, a bottom surface of the base portion includes at least one pin arranged to engage a through hole of a circuit board, and the locking member includes at least one pin disposed at a lower end portion thereof and arranged to be secured to the circuit board.

Each of the sidewalls preferably includes an opening that is arranged to expose a portion of a memory drive unit when the memory drive unit is inserted into the memory drive socket. The opening is preferably substantially U-shaped but may have other shapes.

The plurality of contacts are preferably arranged along both sides of the slot.

The at least one pin of the base portion preferably includes at least two pins.

The at least one pin of the locking member preferably includes at least two pins.

The locking members are preferably disposed in a slot in each of the end walls.

A width of the slot preferably increases from a bottom portion to a top portion of the slot so as to allow the corresponding locking member to be pushed outward when the memory drive unit is inserted into the socket housing.

The locking member preferably includes a finger tab at an upper portion of the locking member which is arranged to be engaged by a person.

The finger tabs of the locking members are preferably inclined outwardly away from one another.

The locking member preferably includes at least one locking projection extending inwardly towards the socket housing, the at least one locking projection is arranged to be engaged with depressions on the memory drive unit when a memory drive unit is inserted into the memory drive socket.

The at least one locking projection preferably has a substantially triangular shape.

At least one of the sidewalls and the end walls preferably includes a polarization structure to allow a memory drive unit to be inserted into the memory drive socket in only one orientation.

The number of contacts in the slot is preferably selected to be greater than the number of contacts provided on a memory drive unit.

An electrical assembly according to another preferred embodiment of the present invention includes the socket as described above, and one of a memory drive, a GPS device, a WiFi device, a software upgrade module, a feature expansion module, and a cable input/output disposed in the socket.

Preferably, the one of the memory drive, the GPS device, the WiFi device, the software upgrade module, the feature expansion module, and the cable input/output preferably a circuit board, and the plurality of contacts engage both sides of the circuit board.

Other features, elements, characteristics and advantages of the present invention will become more apparent from the following detailed description of preferred embodiments of the present invention with reference to the attached drawings.

### BRIEF DESCRIPTION OF THE DRAWINGS

FIG. 1 is a perspective view of the memory drive socket according to a preferred embodiment of the present invention.

FIG. 2 is a side view of the memory drive socket shown in FIG. 1.

FIG. 3 is a top plan view of the memory drive socket shown in FIG. 1.

FIG. 4 is a bottom plan view of the memory drive socket shown in FIG. 1.

FIG. 5 is a side sectional view of the memory drive socket taken along line A-A shown in FIG. 2.

FIG. 6 is a side sectional view of the memory drive socket taken along line B-B shown in FIG. 3.

FIG. 7 is a perspective view a locking member of the memory drive socket shown in FIG. 1.

FIG. 8 is a rear view of the locking member shown in FIG. 7.

FIG. 9 is front view of the locking member shown in FIG. 7.

FIG. 10 is a side view of the locking member shown in FIG. 7.

FIG. 11 is a top view of the locking member shown in FIG. 7.

FIG. 12 a perspective view of the memory drive socket shown in FIG. 1 with a memory drive unit engaged therewith.

FIG. 13 is a side view of the memory drive socket shown in FIG. 12 with a memory drive unit engaged therewith.

FIG. 14 is a top view of the memory drive socket shown in FIG. 12 with a memory drive unit engaged therewith.

FIG. 15 is a cross-sectional view of the memory drive socket taken along line C-C shown in FIG. 13 with a memory drive unit engaged therewith.

FIG. 16 is a bottom plan view with a partial sectional view of a memory drive socket according to another preferred embodiment of the present invention.

FIG. 17 is a side view of the memory drive socket shown in FIG. 16.

FIG. 18 is another side view of the memory drive socket shown in FIG. 16.

FIG. 19 is a side sectional view of the memory drive socket taken along line F-F shown in FIG. 16.

FIG. 20 is a front view a locking member of the memory drive socket shown in FIG. 16.

FIG. 21 is a left side view of the locking member shown in FIG. 20.

FIG. 22 is a right side view of the locking member shown in FIG. 20.

FIG. 23 is a top view of the locking member shown in FIG. 20.

FIG. 24 is a view of detail H shown in FIG. 20.

FIG. 25 is a bottom view of the memory drive socket shown in FIG. 16 with a memory drive unit engaged therewith.

FIG. 26 is a side view of the memory drive socket shown in FIG. 25 with a memory drive unit engaged therewith.

FIG. 27 is a cross-sectional view of the memory drive socket taken along line D-D shown in FIG. 25 with a memory drive unit engaged therewith.

### DETAILED DESCRIPTION OF PREFERRED EMBODIMENT

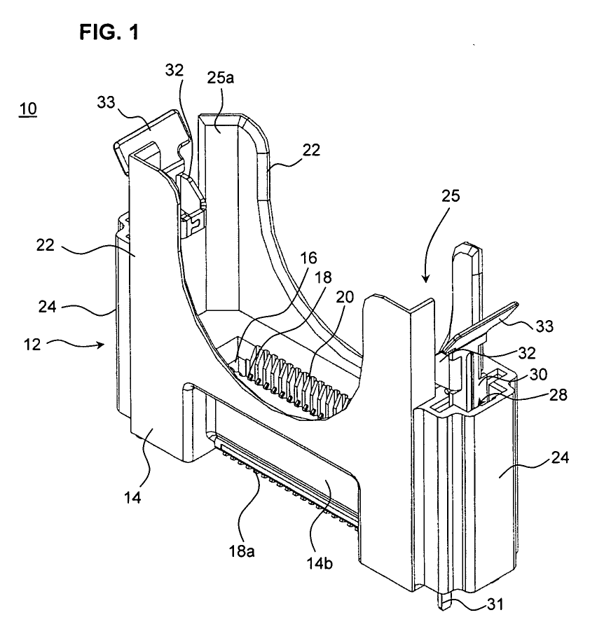

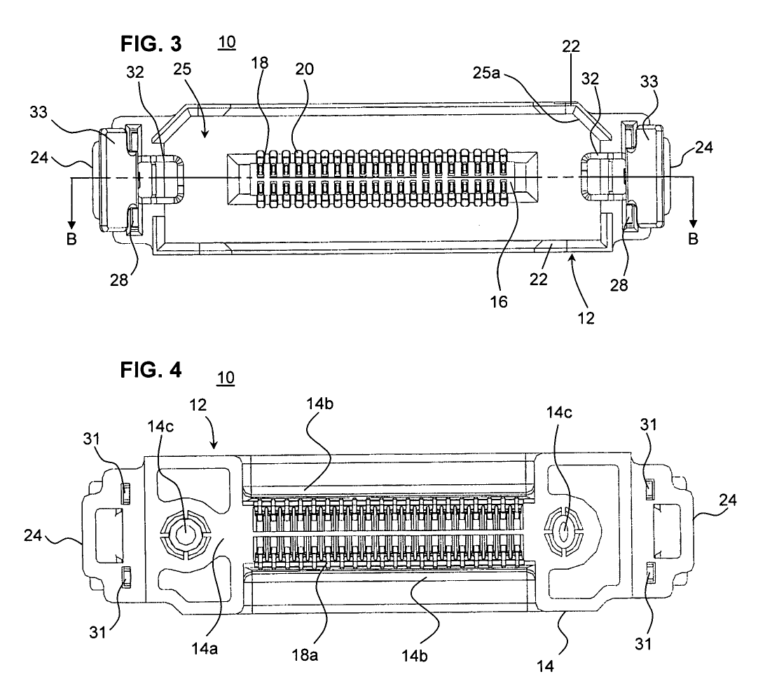

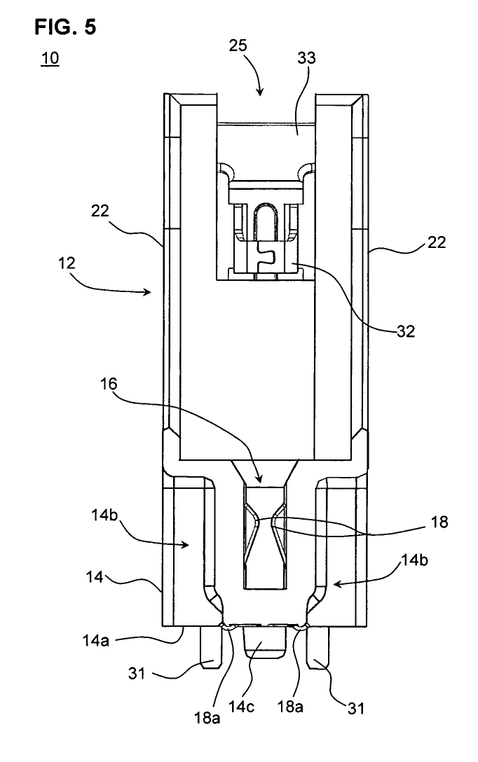

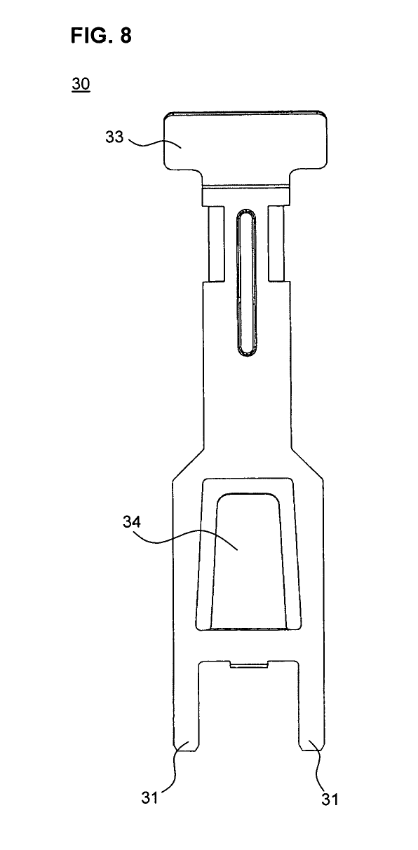

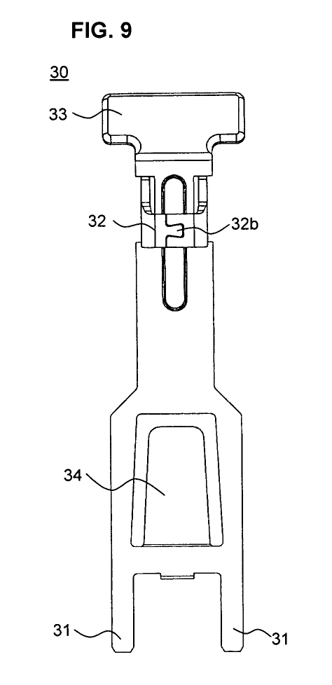

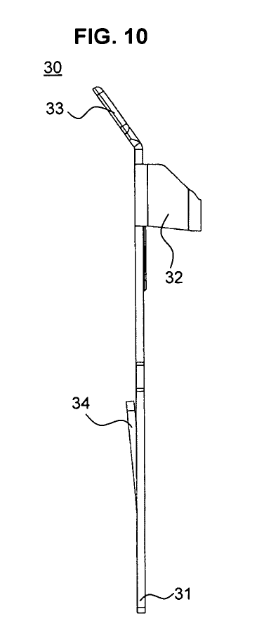

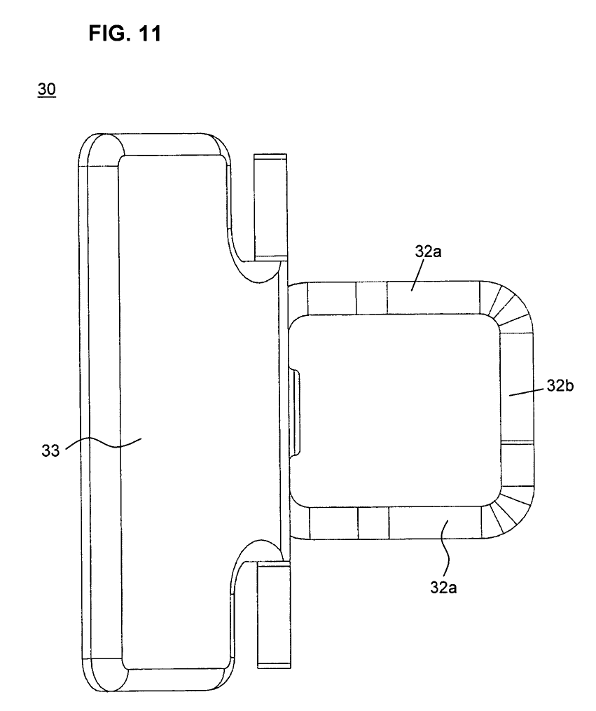

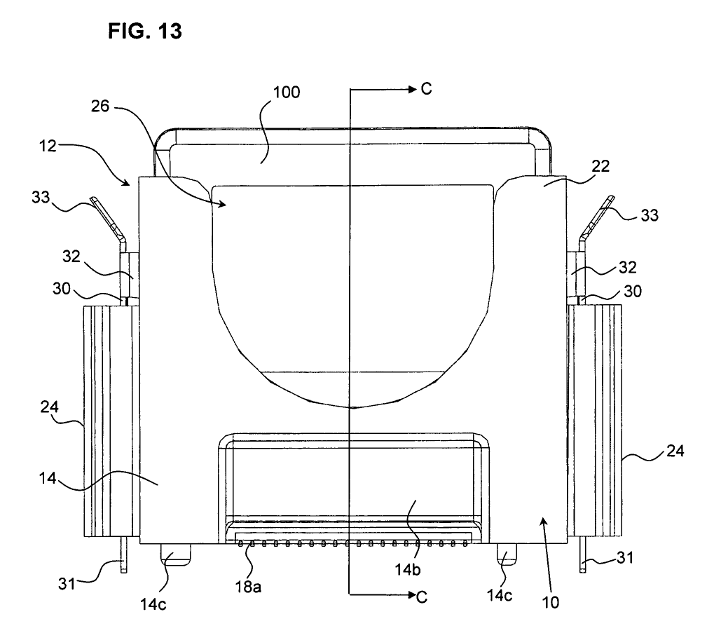

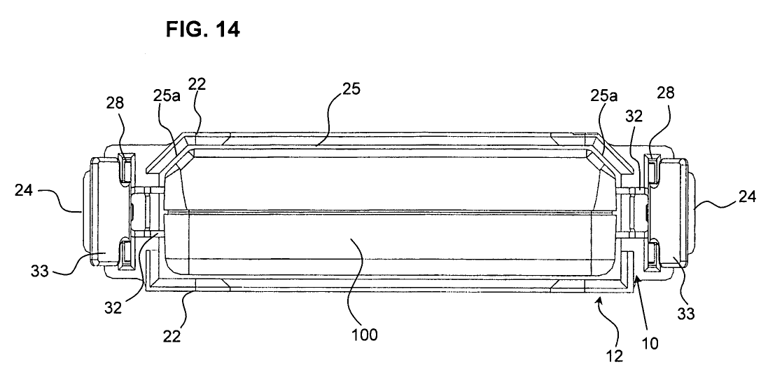

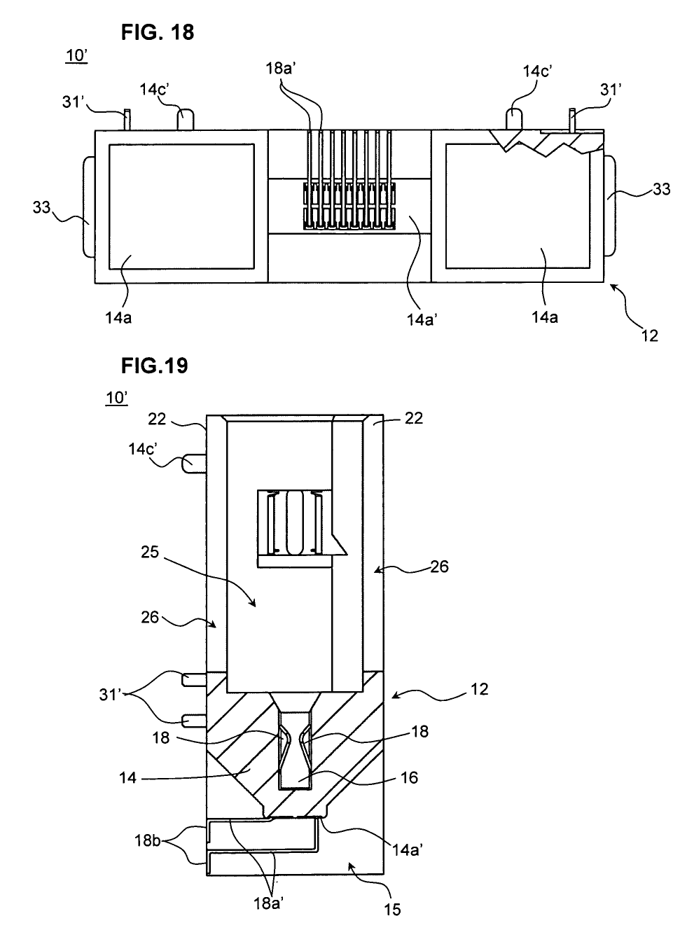

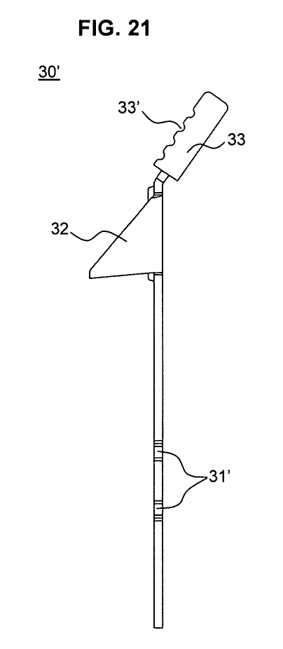

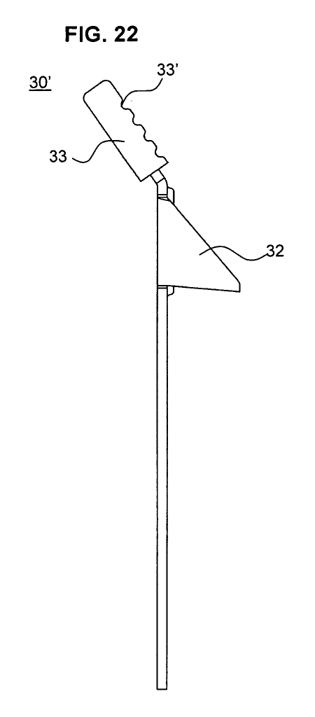

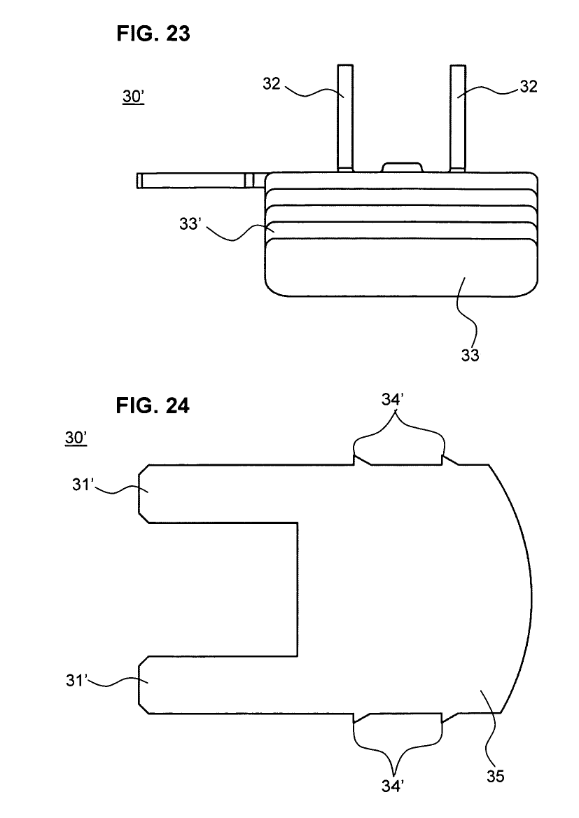

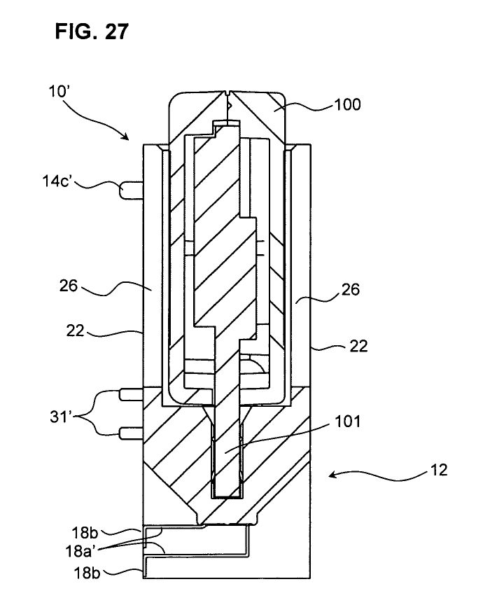

Preferred embodiments of the present invention will now be described with reference to FIGS. 1-27.

FIGS. 1-15 show a vertically oriented memory drive socket 10 according to a first preferred embodiment of the present invention.

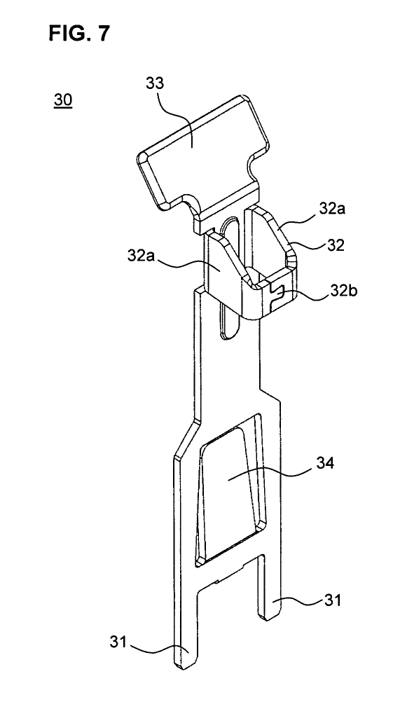

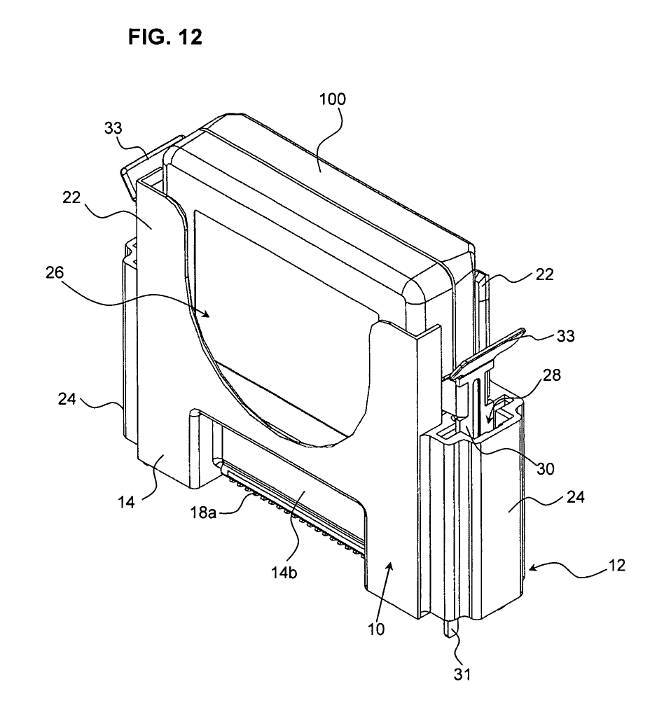

FIGS. 1-6 show the memory drive socket 10 without a memory drive unit 100 engaged therewith, FIGS. 7-11 show the locking member 30 of the memory drive socket 10, and FIGS. 12-15 show the memory drive socket 10 with the memory drive unit 100 engaged therewith.

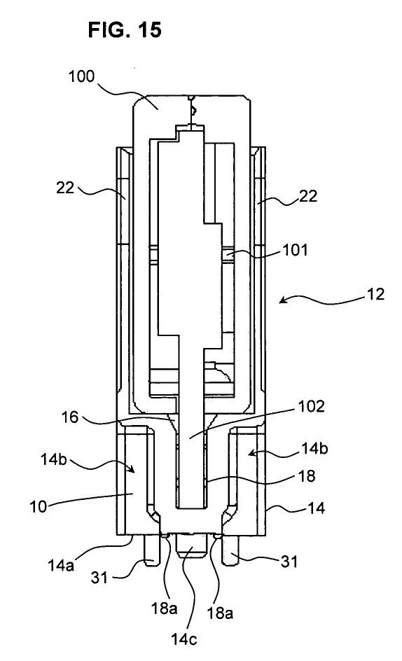

As shown in FIGS. 1-6, a socket housing 12 preferably includes a base portion 14 having a substantially rectangular slot 16 disposed in a central portion thereof. The slot 16 includes a plurality of contacts 18 disposed along longitudinal edges thereof. The plurality of contacts 18 may be disposed along one longitudinal edge of the slot 16 or along both longitudinal edges of the slot 16. Each of the plurality of contacts 18 is disposed in a core 20 provided in the longitudinal edges of the slot 16. The contacts 18 are arranged to be engaged with contact pads (not shown) provided on the circuit board 102 of the memory drive unit 100, as shown in FIG. 15. Preferably, the plurality of contacts 18 are disposed along both longitudinal edges of the slot 16 to provide improved shock absorption and a secure connection between the contacts 18 and the corresponding contacts (not shown) on the circuit board 102 of the memory drive 100. The specific number and arrangement of contacts 18 is not specifically limited, and any suitable arrangement and number of contacts 18 may be used. Preferably, the number of contacts 18 is greater than the number of contacts (not shown) on the memory drive unit 100 to further improve shock absorption. The number of contacts is dependent upon the desired application.

The socket housing 12 is preferably made of a high-temperature insulating material, such as plastic. However, the socket housing 12 may be made of any suitable material. The contacts 18 are preferably made of a conductive metal, and more preferably of a spring alloy. However, the contacts 18 may be made of any suitable conductive material.

Sidewalls 22 of the socket housing 12 extend upward from a base portion 14 of the socket housing 12. The sidewalls 22 are arranged substantially parallel to each other. End walls 24 extend from the base portion 14 between the sidewalls 22. The sidewalls 22 and the end walls 24 are arranged so as to define a slot 25 for receiving the memory drive unit 100. In this preferred embodiment, the sidewalls 22 include substantially U-shaped openings 26 disposed therein to facilitate insertion and removal of the memory drive unit 100. However, the substantially U-shaped openings 26 are not necessarily required. Furthermore, the openings 26 may have any suitable shape. The U-shaped openings 26 provide grip access to memory drive unit 100 to facilitate insertion and removal of the memory drive unit 100 in the memory drive socket 10, and to lower the memory drive socket's 10 center of gravity by reducing the mass in the upper portion of the memory drive socket 10.

Each of the end walls 24 includes a slot 28 arranged to accommodate a locking member 30. The locking members 30 include a locking projection 32 that is arranged to engage depressions (not shown) in the side of the memory drive unit 100 (see FIGS. 1-15) so as to secure the memory drive unit 100 in the memory drive socket 10. In this preferred embodiment, the locking projection 32 includes two projecting arms 32a which extend outwardly from the locking member 30 and are engaged with one another via a mating structure 32b. In the present preferred embodiment, the locking projection 32 has a substantially triangular shape which corresponds to the depressions 101 in the memory drive unit 100. However, the locking projection 32 may have any suitable shape. Alternatively, the two projecting arms 32a may extend outwardly with and not engage each other. In addition, although one locking projection 32 is provided on each locking member 30 in the preferred embodiment, any suitable number of locking projections 32 may be provided.

The locking members 30 are preferably defined by a spring made of metal or molded plastic. More preferably, the locking members 30 are made of metal due to its solderability to a circuit board (not shown) which significantly improves the retention strength of the memory drive socket 10 to the circuit board.

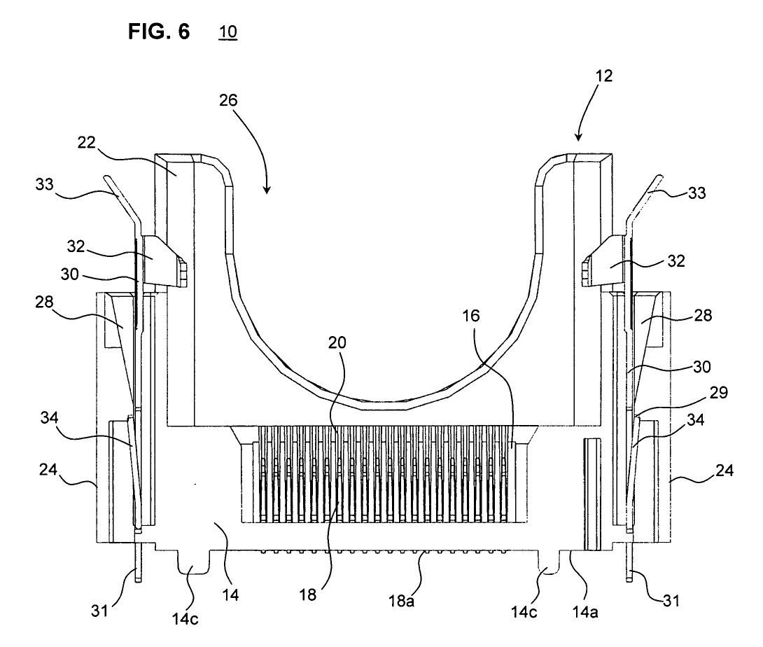

As shown in FIG. 6, the slots 28 extend from an upper portion of the end walls 24 through the base portion 14 such that the pins 31 of the locking members 30 are exposed at a bottom surface 14a of the base portion 14.

FIGS. 7-11 show the detailed structure of the locking members 30.

The locking members 30 include pins 31 extending from a lower portion thereof that are arranged to be connected to a circuit board (not shown). In the present preferred embodiment, two pins 31 are provided at the lower portion of each of the locking members 30. However, any suitable number of pins 31 may be provided. Preferably, a plurality of pins 31 are provided at the lower portion of each of the locking members 30 to provides improved stability and retention strength when the pins 31 are soldered to a circuit board. Alternatively, surface mount pins or press fit pins may be used. However, the stability and retention strength is somewhat deteriorated with these types of pins. The soldering of the pins 31 of the locking members 30 also provides an electrostatic discharge (ESD) path to ground that is spaced away from sensitive electronic devices. As noted above, the locking members 30 may alternatively be made of plastic. However, the ESD path to ground is not provided when plastic locking members are used.

A finger tab 33 extends from an upper portion of the locking member 30. The finger tab 33 is angled outwardly with respect to the socket housing 12 to facilitate engagement with a finger of a person. The finger tabs 33 of the locking members 30 are arranged to be engaged by a person to enable the locking members 30 to be pressed outwardly away from one another to remove the memory drive unit 100. The finger tab 33 preferably includes a slip-resistant surface. In the present preferred embodiment, the slip-resistant surface may include grooves to prevent slippage, for example. However, any suitable surface configuration may be used. In the present preferred embodiment, the slip-resistant surface is preferably integrally formed with the locking member 30. However, the slip-resistant surface may be made of any suitable non-slip material, such as rubber, for example, which is attached to the finger tab 33. In the present preferred embodiment, the slip resistant surface is defined by a textured metal portion of the finger tab 33.

A resilient barb 34 is arranged so as to extend outwardly from the locking members 30 in a direction opposite to the direction in which the locking projection 32 extends. The resilient barb 34 is arranged to secure the locking members 30 in the slot 28. Particularly, when the locking member 30 is inserted into the slot 28, the resilient barb 34 is disposed in a slot 29 so as to prevent the locking member 30 form sliding out of the slot 28. In this preferred embodiment, the barb 34 is provided on each of the locking members 30. However, any suitable number of barbs 34 may be provided. In addition, although the barb 34 preferably extends outwardly in a direction opposite to the direction in which the locking projection 32 extends, the barb 34 may extend outwardly in the same direction that the locking projection 32 extends. Furthermore, although the barb 34 is provided in this preferred embodiment, any other suitable type of securing structure may be used.

The locking members 30 are preferably made of a resilient metallic material such that, when the memory drive unit 100 is inserted into the memory drive socket 10, the locking members 30 are pushed outwardly away from one another, and return to their original orientation as the locking projections 32 engage with the depressions of the memory drive unit 100. Any suitable metallic material may be used, such as spring steel.

As shown in FIG. 6, the width of each of the slots 28 increases from a middle portion to an upper portion to enable the locking members 30 to be pressed outwardly. Alternatively, the width of each of the slots 28 may increase from a lower portion to an upper portion. In the present preferred embodiment, the increased width is achieved via an inclined surface of the slot 28. However, any suitable structure may be provided as long as the width of the slots 28 is greater at the top of the slot 28 than at the bottom of the slot 28, which limits the motion of the locking members 30 and prevents over-stressing and fatigue of the locking members 30.

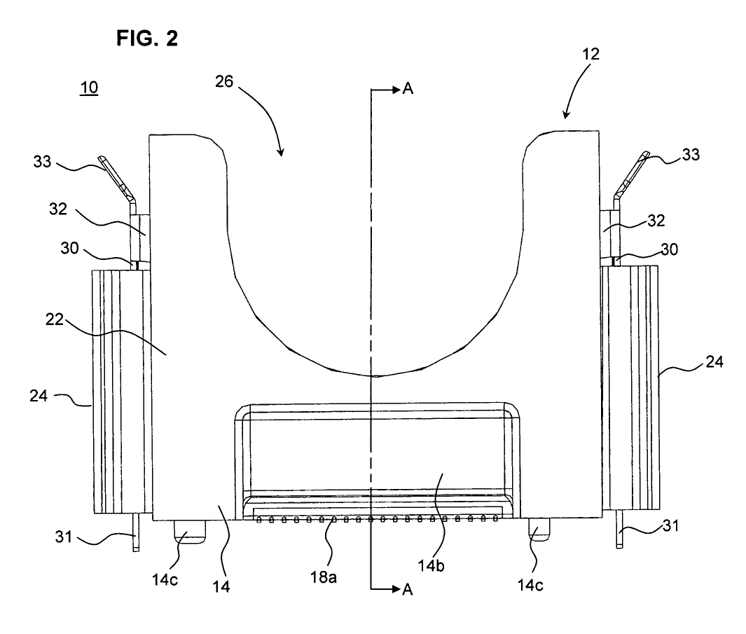

As shown in FIGS. 2, 4-6, 13, and 15, the bottom surface 14a of the base portion 14 of the socket housing 12 includes alignment pins 14c which are arranged to engage corresponding through holes on a circuit board (not shown) to provide polarized alignment of the memory drive socket 10 and to prevent incorrect installation of the memory drive socket 10 on the circuit board (not shown). The pins 14c are preferably arranged to allow the memory drive socket 10 to be attached to the circuit board (not shown) in only one orientation. As shown in FIG. 4, the alignment pins 14c of the present preferred embodiment have different shapes to provide polarized alignment of the memory drive 10 on the circuit board (not shown). However, any suitable arrangement of the alignment pins 14c may be used. For example, a different number or arrangement of alignment pins 14c may be provided on one end of the base portion 14 than at the other end. In the present preferred embodiment, the alignment pins 14c are not secured in the through holes of the circuit board (not shown). However, the alignment pins 14c′ may be secured in the through holes of the circuit board (not shown) via ultrasonic welding, or other suitable method.

As shown in FIGS. 1, 2, and 5, the base portion 14 of the socket housing 12 further includes recessed portions 14b in a central portion thereon. The recessed portions 14b enable visual inspection of the solder joints, washout under the memory drive socket 10 and the contacts, repair and rework of solder joints, infrared (IR) reflow soldering, and probe access to the pads on a circuit board (not shown) to which the memory drive socket 10 is soldered. In the present preferred embodiment, the recessed portions 14b are defined by substantially vertically extending walls. However, the recessed portions 14b may have any suitable shape as long as the recessed portions enable visual inspection of the solder joints, washout under the memory drive socket 10 and the contacts, repair and rework of solder joints, infrared (IR) reflow soldering, and probe access to the pads on a circuit board (not shown) to which the memory drive socket 10 is soldered. For example, the recessed portions 14b may include inclined surfaces that extend inwardly toward the bottom surface 14a of the base portion 14.

As shown in FIGS. 1, 3, 12, and 14, the slot 25 has a shape that corresponds to the shape of the memory drive unit 100. In particular, the slot 25 includes polarization surfaces 25a which permit the memory drive unit 100 to be inserted into the memory drive socket 10 in only one orientation. In the preferred embodiment, the polarization surfaces 25a are provided in two corners along one of the sidewalls of the socket housing 12. However, any suitable polarization arrangement of polarization surfaces 25a may be used to ensure the proper orientation of the memory drive unit 100. It is also possible to not use any polarization arrangement.

The tails 18a of the contacts 18 are arranged to be attached to corresponding pads on a circuit board (not shown). Any suitable type of connection structure may be used, such as solder balls, solder stops, solder charges, and through-hole soldering.

Since the pins 31 and the pins 14c, in addition to the tails 18a of the contacts 18, directly connect the memory drive socket 10 to the circuit board (not shown), the memory drive socket 10 is very securely attached to the circuit board. This connection structure increases the resistance of the memory drive socket 10 to shock, vibration, and other external forces. Accordingly, the reliability and durability of the memory drive assembly is greatly improved, as compared to conventional memory drives. In addition, the combination of the memory drive unit 100 being clamped by the locking members 30, the memory drive unit 100 being in contact with and supported by the memory drive socket 10 on at least five sides, and the strong construction of the locking members 30 securely and stably connects the memory drive unit 100 to the circuit board (not shown).

### Second Preferred Embodiment

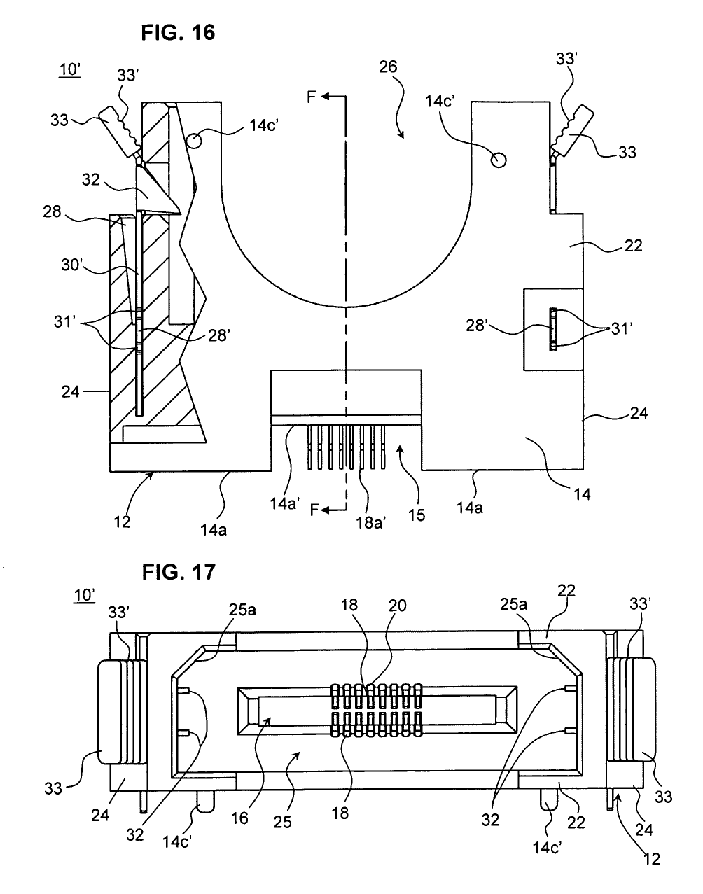

FIGS. 16-27 show a horizontally oriented memory drive socket 10′ according to a second preferred embodiment of the present invention. Elements which are substantially the same as the elements of the first preferred embodiment are referred to by the same reference numbers and further descriptions thereof are omitted.

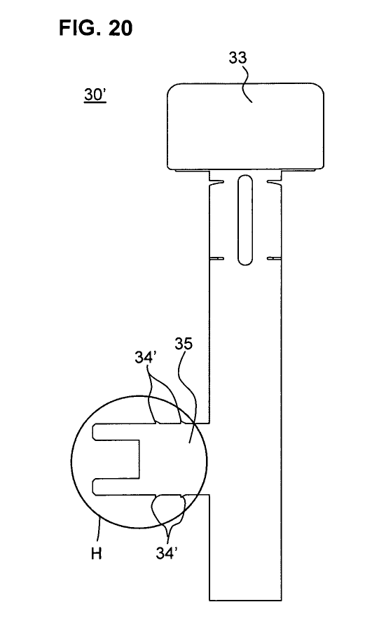

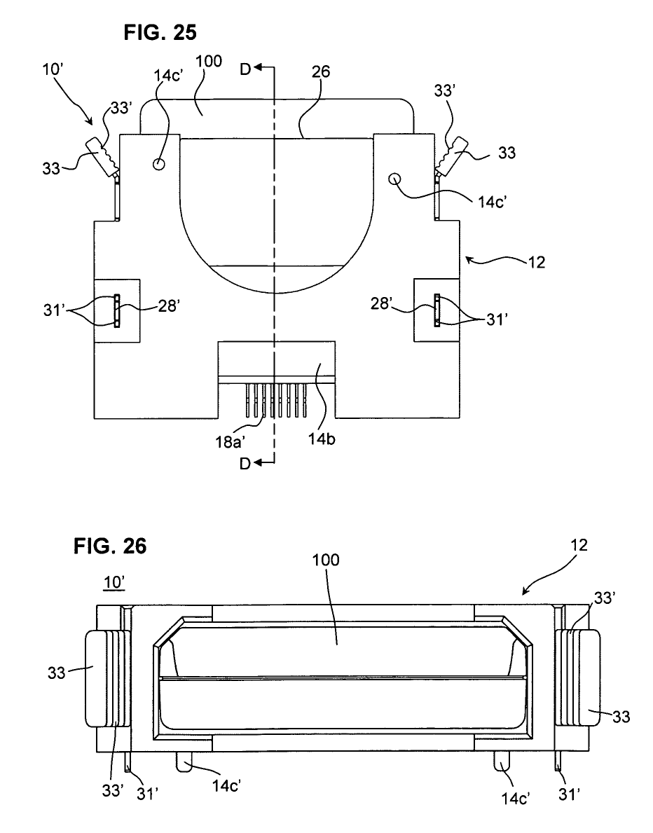

FIGS. 16-19 show the memory drive socket 10′ without a memory drive unit 100 engaged therewith, FIGS. 20-24 show the locking member 30′ of the memory drive socket 10′, and FIGS. 25-27 show the memory drive socket 10′ with the memory drive unit 100 engaged therewith.

The memory drive socket 10′ according to the second preferred embodiment is mounted on a circuit board (not shown) such that one of the side walls 22 is in contact with the circuit board. Accordingly, the structure of the pins 14c′, the locking members 30′, and the tails 18a′ of the contacts 18 has been modified, as compared to those in the first preferred embodiment, so as to enable horizontal mounting of the memory drive socket 10′ on the circuit board.

As shown in FIGS. 16-19, pins 14c′ are provided on the sidewall 22. Similar to the alignment pins 14c of the first preferred embodiment, the alignment pins 14c′ are arranged to engage corresponding through holes on a circuit board (not shown) to provide polarized alignment of the memory drive socket 10′ and to prevent incorrect installation of the memory drive socket 10′ on the circuit board (not shown). The alignment pins 14c′ are preferably arranged to allow the memory drive socket 10′ to be attached to the circuit board (not shown) in only one orientation. The alignment pins 14c′ of the present preferred embodiment may have different shapes to provide polarized alignment of the memory drive socket 10′ on the circuit board (not shown). As shown in FIG. 16, one alignment pin 14c′ is arranged on both sides of the substantially U-shaped opening 26. However, any suitable number and arrangement of the alignment pins 14c′ may be used. In the present preferred embodiment, the alignment pins 14c′ are not secured in the through holes of the circuit board (not shown). However, the alignment pins 14c′ may be secured in the through holes of the circuit board (not shown) via ultrasonic welding, or other suitable method.

As shown in FIGS. 20-24, the locking member 30′ in this preferred embodiment includes an arm 35 which extends outwardly from one side of the locking member 30′, and the pins 31′ extend from an end of the arm 35. As shown in FIG. 25, the arm is arranged such that the pins 31′ extend outwardly from the sidewall 22 having the pins 14c′ disposed thereon. In the present preferred embodiment, two pins 31′ are provided at an end portion of the arm 35 of each of the locking members 30′. However, any suitable number of pins 31′ may be provided. The finger tab 33 includes grooves 33′ on the surface thereof to improve the grip and prevent slippage.

Barbs 34′ are provided along edges of the arm 35 of the locking members 30′ to secure the locking members 30′ in the slot 28′. In this preferred embodiment, two barbs 34′ are provided along each edge of the locking members 30′. However, any suitable number of barbs 34′ may be provided. In addition, although the barbs 34′ are provided in this preferred embodiment, any other suitable securing structure may be used, such as a barb having a similar configuration as the barb 34 used in the first preferred embodiment.

The tails 18a′ of the contacts 18 are arranged to be attached to corresponding contact pads on a circuit board (not shown). As shown in FIGS. 15-18, 26, and 28, the bottom surface of the base portion 14 includes a central portion 14a′ that is spaced inwardly of the remaining portions 14a of the bottom surface of the base portion 14, so as to define a recess 15. The tails 18a′extend from the central portion 14a′ in the recess 15. The tails 18′ include feet portions 18b which are arranged to be substantially aligned with the side wall 22 on which the pins 14c′ are disposed. The tails 18′ can include any suitable type of connection structure, such as solder balls, solder stops, and solder charges.

In the present preferred embodiment, the tails 18a′ preferably include two substantially 90° turns. However, the tails 18a′ may have any suitable arrangement that ensure secure attachment to pads of a circuit board.

Since the pins 31′ and the pins 14c′, in addition to the tails 18a′ of the contacts 18, directly connect the memory drive socket 10′ to the circuit board, the memory drive socket 10′ is very securely attached to the circuit board. This connections structure increases the resistance of the memory drive socket 10 to shock, vibration, and other external forces. Accordingly, the reliability and durability of the memory drive socket is greatly improved, as compared to conventional memory drives.

In the preferred embodiments described above, a memory drive 100 is disposed in the memory drive sockets 10, 10′. However, other modules can be disposed in the memory drive sockets 10, 10′, such as GPS devices, WiFi devices, software upgrade modules, feature expansion modules, and a cable input/output. The contacts 18 of the memory drive sockets 10 and 10′ preferably can be routed for different communication protocols, which allow for the memory drive sockets 10 and 10′ to be used with the different modules. That is, different modules can be used with a single memory drive socket 10 or 10′ mounted on a circuit board by removing and replacing the different modules.

Although the preferred embodiments described above show vertical and horizontally oriented memory drive sockets, the memory drive socket may be oriented in any suitable orientation, as long as the memory drive socket can be securely attached to a circuit board.

It should be understood that the foregoing description is only illustrative of the present invention. Various alternatives and modifications can be devised by those skilled in the art without departing from the present invention. Accordingly, the present invention is intended to embrace all such alternatives, modifications and variations which fall within the scope of the appended claims.

What is claimed is:

1. A socket for electrically connecting a memory drive unit to a circuit board, comprising:
a socket housing including a base portion having a slot disposed in a central portion therein, sidewalls extending upward from the base portion, and end walls extending upward from the base portion and between the sidewalls; and
a locking member arranged to engage a locking structure of a memory drive unit when a memory drive unit is inserted into the memory drive socket; wherein
the slot includes a plurality of contacts disposed therein which are arranged to engage corresponding contact pads of the memory drive unit;
a bottom surface of the base portion includes at least one pin arranged to engage a through hole of a circuit board; and
the locking member includes at least one pin disposed at a lower end portion thereof and arranged to be secured to the circuit board.

2. The socket according to claim 1, wherein each of the sidewalls includes an opening therein, the opening being arranged to expose a portion of a memory drive unit when the memory drive unit is inserted into the memory drive socket.

3. The socket according to claim 2, wherein the opening is substantially U-shaped.

4. The socket according to claim 1, wherein the plurality of contacts are arranged along both sides of the slot.

5. The socket according to claim 1, wherein the at least one pin of the base portion includes at least two pins.

6. The socket according to claim 1, wherein the at least one pin of the locking member includes at least two pins.

7. The socket according to claim 1, wherein locking members are disposed in a slot in each of the end walls.

8. The socket according to claim 7, wherein a width of the slot increases from a bottom portion to a top portion of the slot so as to allow the corresponding locking member to be pushed outward when the memory drive unit is inserted into the socket housing.

9. The socket according to claim 1, wherein the locking member includes a finger tab at an upper portion of the locking member which is arranged to be engaged by a person.

10. The socket according to claim 9, wherein the finger tabs of the locking members are inclined outwardly away from one another.

11. The socket according to claim 1, wherein the locking member includes at least one locking projection extending inwardly towards the socket housing, the at least one locking projection is arranged to be engaged with depressions on the memory drive unit when a memory drive unit is inserted into the memory drive socket.

12. The socket according to claim 11, wherein the at least one locking projection has a substantially triangular shape.

13. The socket according to claim 1, wherein at least one of the sidewalls and the end walls includes a polarization structure to allow a memory drive unit to be inserted into the memory drive socket in only one orientation.

14. The socket according to claim 1, wherein the number of contacts in the slot is selected to be greater than the number of contacts provided on a memory drive unit.

15. An electrical assembly comprising:
the socket recited in claim 1; and
at least one of a memory drive, a GPS device, a WiFi device, a software upgrade module, a feature expansion module, and a cable input/output disposed in the socket.

16. The electrical assembly according to claim 15, wherein the at least one of the memory drive, the GPS device, the WiFi device, the software upgrade module, the feature expansion module, and the cable input/output includes a circuit board, and the plurality of contacts engage both sides of the circuit board.
